(19) United States
(12) Patent Application Publication
(10) Pub. No.: US 2007/0004332 A1
(43) Pub. Date: Jan. 4, 2007

(54) Method of operating a satellite radio system

(76) Inventor: Laurence Kaiser, Glenview, IL (US)

Correspondence Address: Jon P. Christensen;WELSH & KATZ, LTD., 22nd Floor, 120 S. Riverside Plaza, Chicago, IL, 60606-3912, US

(21) Appl. No.: 11/453,662

(22) Filed: Jun. 15, 2006

Related U.S. Application Data
(60) Provisional application No. 60/691,219, filed on Jun. 16, 2005.

(51) Int. Cl. H04H 1/00; H04H 7/00; G06Q 30/00

(52) U.S. Cl. 455/3.04; 455/3.06; 705/26

(57) ABSTRACT

A method and apparatus are provided for operating a wireless global communication system. The method includes the steps of providing a live performance to a live audience located at a predetermined location, generating an entertainment content from the live performance for transmission through the wireless global communication system and selling a subscription to a person of the audience located at the predetermined location that allows the person to receive the entertainment content of the global communication system through a wireless receiver of the subscribing person.

### FIELD OF THE INVENTION

The field of the invention relates to communication systems and more particularly to satellite communication systems.

### BACKGROUND OF THE INVENTION

Consumer satellite radio communication systems are generally known. Such systems typically rely upon two or more satellites to broadcast audio information to portable consumer radio receivers on a subscription basis only. Service within the U.S. is generally available on a coast-to-coast basis.

The receivers are specialized for satellite radio and may be purchased through any of a number of consumer outlets. Once a receiver has been obtained, the buyer must subscribe to service through a satellite operator in order to receive programming services.

Subscription in this case means providing the satellite operator with a promise to pay (e.g., by providing a billing address, credit card information, etc.) in exchange for a programming key. The programming key allows the consumer radio to decode the encrypted radio signal.

Once a consumer has subscribed to service, the consumer may receive programming services through a relatively large number of radio channels (e.g., 100 channels). Programming may include any of a number of topics (e.g., music, news, sports, talk, etc.).

While satellite radio is enjoyed by many people, the group of users is relatively small when compared to the potential market for satellite radio. In no small part, the relatively small number of users may be directly related to the obstacles that interfere with the marketing of satellite radio.

For example, the receiver used by a consumer to receive satellite radio has no other use. As a consequence, a consumer is reluctant to invest in a receiver unless he/she is relatively certain that they will appreciate the experience of satellite radio.

The only other source of satellite radio is through the Internet and for the consumer to subscribe to satellite radio over the Internet. In addition to the expense of paying for a subscription, a connection through the Internet deprives the consumer of the sound quality and mobility that are the hallmarks of satellite radio.

As a consequence, consumers are left with few choices when it comes to the decision of whether or not to subscribe to satellite radio. On the one hand, the consumer is asked to assume the risk of investing in a satellite radio receiver that they could not otherwise use if they canceled their subscription or, on the other hand, to be limited by the drawbacks of an internet connection. Because of the importance of the entertainment industry, in general, and of satellite radio, in specific, a need exists for more effective and transparent ways to market satellite radio.

### SUMMARY

A method and apparatus are provided for operating a wireless global communication system. The method includes the steps of providing a live performance to a live audience located at a predetermined location, generating an entertainment content from the live performance for transmission through the wireless global communication system and selling a subscription to a person of the audience located at the predetermined location that allows the person to receive the entertainment content of the global communication system through a wireless receiver of the subscribing person.

### BRIEF DESCRIPTION OF THE DRAWINGS

FIG. 1 is a block diagram of a wireless global communication system under an illustrated embodiment of the invention; and

FIG. 2 is a block diagram of a live satellite radio space used by the system of FIG. 1.

### DETAILED DESCRIPTION OF AN ILLUSTRATED EMBODIMENT

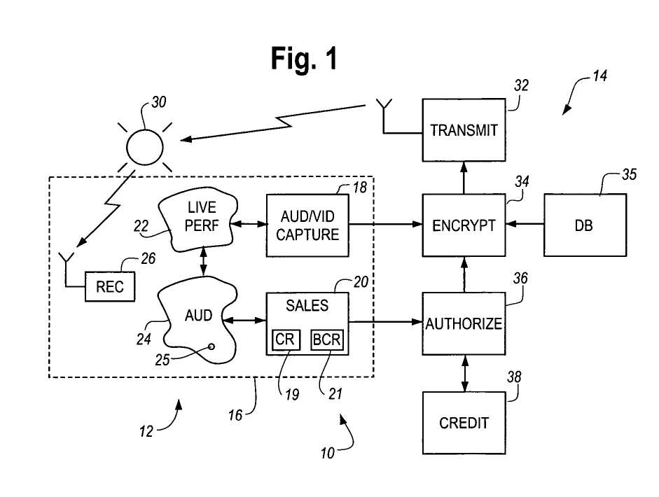

FIG. 1 depicts a wireless global communication system (e.g., satellite radio) for simultaneously providing entertainment content to millions of consumers under an illustrated embodiment of the invention. Under the prior art, direct sale of satellite radio to consumers has been impractical because of the difficulty of allowing potential subscribers to fully experience satellite radio first hand. In this case, “first hand” means that consumers (potential subscribers) have the ability to see and to interact with satellite performers and the support personnel of the satellite radio operating organization (satellite operator). As a consequence, the direct sale of satellite receivers has been relegated to other retail outlets (e.g., “big box” stores) or new car sales (OEM) where a consumer has only limited access to satellite radio before making a purchase.

Central to the concepts disclosed herein is the understanding that consumers, performers and support personnel of the satellite operator are brought together in some central predetermined location controlled by the satellite operator where the environment of live satellite radio can be directly experienced. The use of the central location (or a number of central locations) provides a number of benefits that cannot be achieved through other methods. On a first level, the use of a central location allows consumers to be educated as to what satellite radio is, how it works and the programming features available through satellite radio.

On another level, the central location entertains consumers on any of a number of different levels. On a first level, satellite radio operators (e.g., Sirius Satellite Radio, XM Satellite Radio, etc.) typically generate approximately 100 satellite radio channels that are simultaneously transmitting entertainment content. By locating at least some of the studios that generate content for each radio channel at the central location, consumers can visually observe and be entertained by the entertainment and/or programming content occurring within the studios.

The presence of high quality entertainment inherently provides an attraction for consumers. It also provides the opportunity for sales (e.g., satellite radios, subscriptions for satellite radios, etc.). Sales, in this case may be based upon the traditional consumer/sales personnel interaction or may be automated. For example, portable satellite radios have become sufficiently compact as to be dispensed through vending machines. A consumer may simply present a credit card to the vending machine not only to purchase a satellite receiver and/or to subscribe for satellite service based upon regular billing through the credit card.

The central location may also be used as a means of providing subscriber rewards. Subscriber rewards may be provided in the context of reduced monthly rates when a consumer subscribes for satellite service or rebates when a subscriber brings their friends to experience the satellite radio environment at the central location, even if the friends do not choose to subscribe.

Live satellite radio may also be used as a retention tool. In this case, the live performances and other services available at the central location may become part of the subscriber's social network. Alternatively, the central location may also provide a source of other related retail opportunities that may be of benefit to subscribers, as discussed in more detail below.

Of benefit to the satellite operator is lower subscriber acquisition costs. In this regard, satellite radio has grown slowly because of the difficulty of attracting subscribers. The concept of live satellite solves the problem of selling hardware and subscriptions (to use the hardware) as part of an integrated solution that ties acquisition to the satellite radio experience.

Another benefit arises from the valued added by the involvement of advertisers and partners. For example, the central location allows advertisers to participate in the environment in a manner that adds a physical dimension to that which would, otherwise, be tuned out as an unwanted commercial. Partners benefit from such things as co-branding opportunities.

Turning now to the figures, FIG. 1 shows a live satellite portion 12 and a encryption and authorization portion 14 of the satellite system 10. The live satellite portion 12 is used to generate entertainment content. The encryption and authorization portion 14 is used to control transmission of entertainment content to subscribers of the system 10.

Included within the live satellite portion 12 is a capture device (e.g., a camera, microphone, etc.) 18 located within the predetermined geographic area 16. The capture device 18 captures entertainment content (e.g., audio, video, audio/video, etc.) from a live performance 22 performed by live performers performing in the physical presence of a live audience 24.

While FIG. 1 shows a single capture device 18 and live performance 22, it should be understood that the predetermined area 16 contains a number of capture devices 18 and live performances. It should also be understood that one or more capture devices 18 generates entertainment content for respective channels of the system 10.

The entertainment content from the capture device 18 is sent to an encryption device 34 where the entertainment content is encrypted using know encryption methods and frequency translated to a transmission (channel) frequency. The frequency translated entertainment content is combined with entertainment content (on other satellite radio channels) from other capture devices 18 and/or entertainment content from a database 35 and transmitted via a transmitter 32 over respective channels of the system 10 to a satellite 30. From the satellite 30, the respective channels are retransmitted to subscriber devices 26.

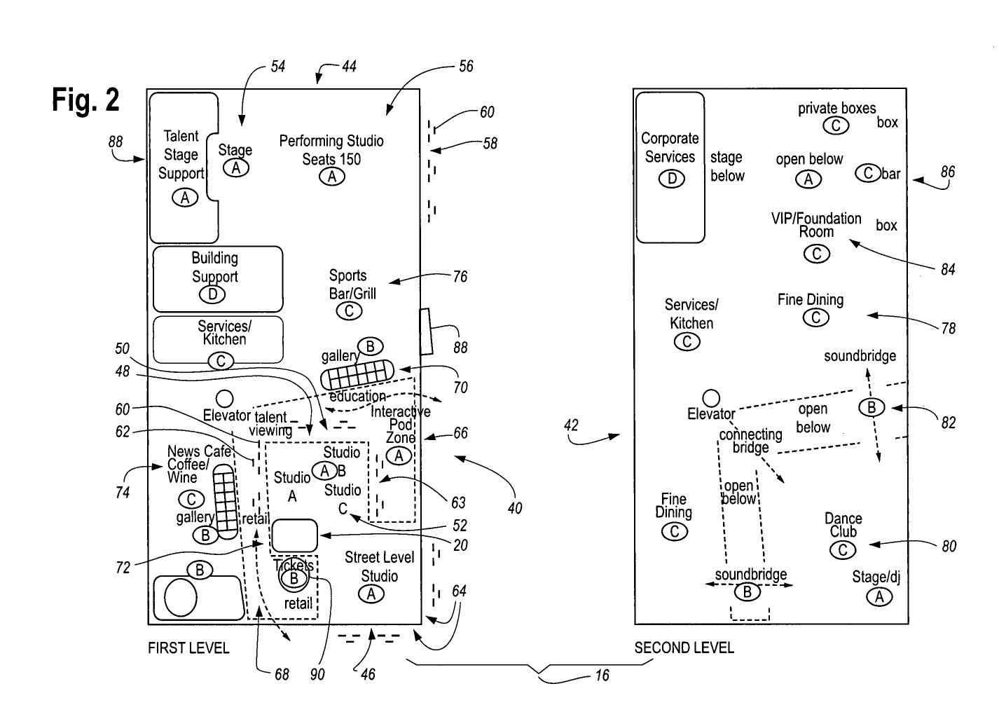

FIG. 2 depicts an exemplary embodiment of the predetermined area 16 used for live satellite radio. As shown in FIG. 2, the area 16 may be divided into a first portion 40 and a second portion 42. The first portion 40 may be a first floor and the second portion 42 may be a second floor located directly over the first portion 40.

Within the first portion 40 may be a number of studios 44, 46, 48, 50, 52. At least some of the studios (e.g., performing studio 44) may be relatively large (e.g., 7,000 square feet) and have a stage 54 and seating for an audience 56. The performing studio 44 may be used for live shows (e.g., talk, comedy, celebrity events, concerts, album releases, live radio shows, broadcast corporate events, etc.). One or more green rooms 88 may be provided backstage for performers and for after event parties.

The studio 44 may have one or more viewing windows 58. The viewing windows 58 may be located on an exterior of the space 40 allowing passersby 60 on a sidewalk outside the space 40 to view the live satellite performances.

In other cases, the viewing windows 60 may be located within the space 40. In this case, the audience 62 within the space is separated from the performance within the studio 48 by the viewing window 60.

At least some of the studios (e.g., 46) may be street level studios of a somewhat smaller size (e.g., 1000 square feet) with street level viewing windows 64 for viewing by passersby. The street level studio 46 may be used for live broadcasts with small audiences, but can also be expended to include outside viewers, group corporate broadcasts, live shows or corporate events.

Other studios (e.g., 48, 50, 52) may also be somewhat smaller (e.g., studio 48 may be approximately 500 square foot, studios 50, 52 may together total 500 square foot). The studio 48 may be used by a talent disk jock (DJ) with 3-4 guests (live recording) with fan viewing through the windows 60. The studios 50, 52 may be used by a talent DJ with 1-2 guests (live recording) with fan viewing through windows 63.

A booth/pods area 66 may also be provided with a number of computer terminals. The terminals may be used for selecting and downloading podcasts through the Internet using either the RSS or Atom syndication formats. Podcasts may be downloaded to personal listening devices (e.g., an IPod) or played directly through the terminals. Satellite radio channels and episodes may be selected by customers and provided free of charge for loading into the personal listening devices of customers from a server of the system 10. The booth/pods area 66 may also be used for group chat, blogging and as a gaming area.

The space 40 may also include areas 68 for retail sale. In retail area 68, new products (e.g., satellite radio receivers) may be displayed. The area 68 may also include display areas for co-branding products (e.g., auto showings, sports partners, philanthropic events).

The space 40 may also include an area 70 for satellite education. The education area 70 may include a gallery of the history of satellite radio and how satellite radio works.

Associated with the areas 68, 70 is a customer service, product and membership sales area 72. The sales area 72 may be at least partially automated wherein a consumer 25 may select a product (e.g., a satellite radio 26) and present his credit card to a point of sale terminal 20 (FIG. 1). Alternatively, the consumer may purchase satellite radio 26 from a retail partner and proceed to the area 72 to subscribe for service. As above, the consumer may present a credit card to the terminal 20.

The credit card may be read by a credit card reader 19 attached to the terminal 20. The terminal 20 may then ask for a model number of the satellite radio and an electronic serial number (ESN) of the product. A bar code reader 21 attached to the terminal 20 may read a model number, serial number and the ESN from the radio 26 or from the packaging containing the radio 26. Once the information is received, the terminal 20 may transfer the information to an authorization processor 36. Within the authorization processor 36, a credit application may first verify the credit of the consumer through a credit service database 38. The authorization processor 36 may also verify that the model number and serial number of the satellite radio 26 are valid alphanumeric sequences.

If the credit database 38 accepts the charge, then the authorization processor 36 may accept the sale and return a sale/subscription contract to the consumer 25 through terminal 20. The terminal 20 may present the contract to the consumer 25 in either hard copy or on a screen. The consumer 25 may sign the contract to complete the transaction. In the case of a hard copy of the contract, an employee of the satellite operator may scan the contract into the terminal 20.

Once the consumer 25 has signed the contract, the terminal 20 may return the image of the contract to the authorization processor 36. The authorization processor 36 may authenticate the signature and take steps to active the satellite radio 26 at the same time as (i.e., concurrent with) the sale.

Alternatively, the consumer 25 may pay cash for the radio 26 and subscription. In this regard, there may no need for any contract and only minimal need for contact information. The consumer 25 may prepay a subscription rate for some predetermined period (e.g., 6 months, 12 months, etc.). The consumer 25 may provide contact information so that the satellite operator may send a reminder to the consumer 25 near the end of the subscription period to renew the subscription.

As a further alternative, the satellite operator may structure the sale as a trial period leading to sale. In this case, the consumer 25 may simply provide some form of identification (e.g., his credit card number) for some trial period (e.g., 3 months). At the end of the trial period, the satellite operator charges the credit card or the consumer 25 otherwise arranges for payment of the costs for the radio 25 and subscription.

To activate the satellite radio 26, the authorization processor 36 may encrypt the electronic serial number of the radio 26 into an authorization command to be transmitted to the radio 26 through the transmitter 32 and satellite 30. Once the satellite radio 26 receives the authorization command, the radio 26 uses the authorization command to configure an internal decoder allowing receipt and decoding of satellite radio signals in accordance with the sale/subscription agreement.

If the sale or activation cannot be completed because of a low credit balance or because of a defective radio, then the consumer may cancel the sale. If the problem is a defective radio 26, then the consumer may simply retrieve another radio 26 and start over.

In contrast to the previously described areas which are closely related to acquiring satellite subscribers, additional portions of the lower level 40 and upper level 42 may serve a different purpose in the process of acquiring subscribers. In this regard, the additional portions operate to provide a respite in which visitors (e.g., subscribers and customers) may relax.

For example, a first area 74 of the lower level 40 may include a news café and wine bar. Satellite education may be automatically provided via walls screens, terminals or listening pods and/or employees/contractors of the satellite operator may provide educational seminars. The area 74 may provide a teen hangout (where liquor laws permit) and an area for celebrity sightings. Interactive terminals 20 may also be provided for subscriber sign-up.

Another area 76 may be provided for a sports bar and grill. The sports bar and grill may offer casual dining and listening booths for satellite radio.

The sports bar and grill area 76 may offer co-branding opportunities. For example, the satellite operator and a local sports team may together offer a special satellite radio service featuring sports events as a central theme.

A still further area 78 may offer fine dining. The fine dining may be offered by a local bar/restaurant and may function as a place to “see and be seen”.

Another area 80 may be reserved as an exclusive dance club. The area 80 may provide a small band venue or area for exposure of local talent. Entertainment may also be provided via pod casts or DJ dance parties.

A sound bridge 82 may be provided with private listening booths. The sound bridge 82 may oversee the space below (e.g., studios 48, 50, 52). The sound bridge 82 may provide the setting for a “hip nest” or private VIP setting.

A VIP/foundation room 84 may also be provided with a private view of the stage 54 below. The VIP/foundation room 84 may be used to provide membership rewards or for corporate events.

An upper level bar and private VIP booth area 84 may also be provided with a private view of the stage 54 below. The area 84 may be provided for corporate events or for membership rewards.

In order to further coordinate the overall impact of the live satellite radio experience, a ticket broker area 90 may be provided proximate the entrances of the space 16. The ticket broker area 90 may be used to provide tickets allowing access to the various areas for special events (e.g., studios 44, 46, 48, 50, 52, the dance club 80, VIP room 84, etc.).

Providing live satellite radio within the live satellite radio space 16 provides synergies for acquiring satellite radio subscribers on any of a number of different levels. On a first level, it becomes possible to allow the consumer to experience the performance of the satellite radio hardware at the particular subscription level that the consumer chooses before the consumer purchases the hardware. The acquisition of hardware at the same location as the subscription avoids inconsistencies in subscriber expectations and, if there are inconsistencies, allows the inconsistencies to be resolved before the sale is complete. Further, if problems develop later, the subscriber 25 has a single location from which service may be received rather than having to having to resolve problems on his own or having the experience degenerate into finger-pointing between the hardware maker and satellite operator.

In addition, education about the hardware and satellite radio service may be tailored to the precise combination purchased. In this way, the consumer may experience different combinations of services in a manner that is most comfortable to the consumer before the consumer commits to the experience.

The live satellite radio space 16 also allows the satellite operator to evaluate the overall impact of programs. Surveys of consumers 25 may be conducted during programs within any of the studios 44, 46, 48, 50, 52 to evaluate the effectiveness of the programs. Participants may be rewarded via tickets to the VIP rooms 84.

Further, the live satellite radio space 16 allows the particular type of satellite radio provided by the satellite operator to be branded in the mind of the consumer. In this context, branding may be accomplished under any of a number of different live performance concepts (e.g., branding the experience provided by a live performance; creating a programming specific brand awareness or performer specific brand awareness, etc.). Co-branding opportunities may be created with retail partners by the sale of related (or even unrelated) products within the environment of the branded performance. As still another secondary effect, philanthropic brand awareness may be created by combining philanthropic efforts with other brand concepts

As used herein, branding the experience of a live performance means providing a distinctive environment in which a subscriber associates the sensory experience with the provider of the experience. While the performer(s) could be considered to be the provider of the experience, the contribution of the performer is only a part of the overall distinctive environment experienced by the consumer. In this case, the organization that sponsors the performance (the satellite operator) is the provider of the experience even though performers, advisors and consultants provide the creative content of the performance. Similarly, the combination of branded performances may together define a branded service (e.g., satellite radio) that is associated with the name and/or trademark of the organization providing the service.

Similarly, creating programming specific brand awareness means creating a format of the performance that is distinctive. In this case the distinctive format of the performance becomes identified with the organizational provider of the performance (e.g., with a trademark or the organization providing the performance).

As a secondary effect, a performer specific (e.g., a disk jockey) brand awareness may be created as a secondary effect. In this case, the disk jockey specific brand awareness may be created by the disk jockey following the distinctive format. As another secondary effect, co-branding opportunities may be created with retail partners by the sale of related (or even unrelated) products within the environment of the branded performance. As still another secondary effect, philanthropic brand awareness may be created by combining philanthropic efforts with other brand concepts. In this regard, a philanthropic brand awareness by be created by combining philanthropic efforts with branded experiences, performances or programming formats.

In addition to the branding effects of the live performances, the specific elements of the space 16 also provide benefits on other levels. For example, the studios 46, 48, 50, 52 may generate profits through ticket sales. The ticket sales may allow consumers to directly view and/or participate in interviews with big name celebrities.

The studios 46, 48, 50, 52 may also generate profits through advertising and sponsored programs (e.g., a skiing report sponsored by a local ski resort; a real estate market report by REMAX, etc.). The studios 46, 48, 50, 52 may also be used for infomercials directed to consumers within the audience.

Other activities within the studios 46, 48, 50, 52 that are more directly related to branding may include the activities of artists. Such activities may include record releases, artist confidential performances or opportunities for fans to meet the artist. The studios 46, 48, 50, 52 may also be used for the recording of shows and/or transmission of the shows.

In general, the live satellite radio spaces 16 may be simultaneously provided at a number of geographic locations over a wide area or in any given locale. In this case, the studios 46, 48, 50, 52 may function to provide local access by the audience.

The studios 46, 48, 50, 52 provide a means for an audience to have hands-on experience with satellite radio. In one example, consumers may simply be an audience at a show made available within a studio 46, 48, 50, 52. Alternatively, the audience may be physically close to the DJ/performer allowing for at least some interaction between the audience and DJ/performer.

The use of the performing studios 44 may have similar benefits. In this case, successful programs provide significant revenue from advertising. Programs with significant revenue may reward the performer for the success of the advertising by sharing some of the revenue with the performer. Alternatively, the success of a program may attract sponsors to further reduce the overhead of any particular program.

Successful programs within the programming studios 44 may also foster brand awareness. In this case, a successful performance allows the audience to live the experience of being a part of a show/DJ event.

Benefits also accrue to the members of the audience from performances within the performing studios 44. On the one hand, the intimate relationship of one fan with a performer contributes not only to the fan's memories, but also to the memories/relationship of other fans in the audience with the performer.

Artists also benefit from visits to the performing studios 44. On a first level, the artist benefits from exposure to fans. The performing studio 44 provides a place to stop when the artist is on the road. The artist may also generate a larger fan base from unscheduled walk-ins on previously scheduled performances.

The performing studios 44 may also be used for customer rewards. For example, the performing studios 44 may be used to provide exclusive shows for satellite subscribers.

Similarly, the VIP rooms 84 provide benefits both related and unrelated to brand awareness. On a first level, the VIP rooms 84 may generate a direct profit to the satellite operator through membership fees paid by exclusive members. Profits may also be generated from ticket sales paid to view performances in studios located below the VIP rooms 84 and from drink sales.

On another level, the VIP rooms 84 can make a direct contribution to brand awareness. In this case, the VIP rooms 84 allows people to be exposed to the satellite brand name with parties and business dinners.

Artists may also be used to add value to the use of the VIP rooms 84. Value may be added in this case via private events with fans/fan clubs.

The VIP rooms 84 may also be used for customer rewards. For example, private membership allows customers visual access to any studio within sight of the VIP rooms 84. Further, access is direct with no waiting.

The disco/club 80 may provide similar benefits. Profits to the satellite operator may be provided by DJ events, plus CD sales. Profits may also be derived from cover charges and drink sales.

The disco/club 80 also contributes to brand awareness. In this case, brand awareness is derived from the intimate culture level and attitude generated by the environment within the disco/club 80.

The disco/club 80 also adds value to the customer experience. The disco/club 80 is a great place to have fun, either locally or on the road. It allows the customer to be part of something that the customer can take home (i.e., pod parties). The disco/club 80 also provides a forum for private events. The disco/club 80 also provides a mechanism for rewarding subscribers (e.g., short term membership cards).

The green rooms 88 may generate profits from sponsored events, or after event parties. Performers may use the green rooms 88 as a place to get away between performances.

The green rooms 88 may also be used for customer rewards. In this case, the green rooms 88 may be used to allow customers to meet performers.

The café 74 may be used by a service provider (e.g., Starbucks). The café 74 may be either leased or operated under a sharing (i.e., co-branding) agreement. The café 74 may benefit the service provider and satellite operator through profit from the sale of food and drinks. The satellite operator may also profit from the advertising of any service provider that draws consumers to the live satellite space 16.

The café 74 may also contribute to brand awareness for the satellite operator because it exposes visitors to satellite radio in a relaxed environment of mood and sound. The café 74 may also have value to the community by providing a local hang out. Satellite subscribers may be rewarded within the café 74 through the use of coupons for free products.

The bar 86 may have a sports format (i.e., an ESPN zone). The bar 86 may generate profit for the satellite operator through sale of food, drinks and sports products.

The satellite operator may also generate revenue through advertising. For example, the bar 86 may be used to interview sports figures while at the same time advertising the products of sponsors of the interviews. Alternatively, the bar 86 may function as an event location. In this case, the bar 86 may have a number of TV monitors that display sports events along with the advertisements of paying advertisers.

The bar 86 may also foster a brand awareness of the satellite operator. Brand awareness is fostered in this context by the attractive style of the sports format.

The bar 86 may also be used for customer rewards. In this case, discount coupons may be distributed to customers and to help create the impression that the bar 86 is a great place to go and to meet friends.

The retail area 68 may be used by any of a number of different vendors (e.g., Apple Computer). Again, space within the retail area 68 may be leased or shared under a co-branding agreement. The merchandise may be directly branded (e.g., Hard Rock) or name brand. The retail area 68 may generate a direct profit from the display and sale of products. The retail area 68 may also be used to display new (not yet available) products.

In addition to profit from sales, the retail area 68 may generate revenue from advertising. In this case, new product displays from retail partners may result in advertising income to the satellite operator.

As in other areas, the retail area 68 fosters brand awareness for the satellite operator. In this case, the environment of high quality suppliers of sound reproduction and related equipment creates a perception of quality.

The presence of high quality suppliers in the retail area 68 adds value for the customer. In this case, the customer knows that he/she will receive knowledgeable help. The customer also knows that he/she will also receive access to the latest information and products.

The presence of high quality suppliers in the retail areas 68 also provides value to artists. In this case, the sale of high quality sound equipment has the effect of increasing the sale of audio media (e.g., CDs).

The presence of the retail areas 68 on the first floor also creates the environment of a local hangout. The presence of numerous audio suppliers creates a hands-on environment where products may be easily tested before purchase.

The retail areas 68 also functions as a customer reward area. Customers know where to go to receive help and service. Complimentary items (e.g., coffee cups labeled with the name of the satellite operator) may be given away The retail areas 68 provide physical access to products instead of merely on-line or over-the-air radio descriptions of products.

The sales office 72 provides a hub for customer service and experience. The sales office 72 may handle both inside and outside sales. The sales office 72 enhances advertising effect and advertising income to the satellite operator because advertisers can control quality of information shared because of the relationship with the satellite operator.

The retail space 68 also contributes to brand awareness. In this case, care of the customer becomes part of the definition of the brand promulgated by the satellite operator.

The customer care aspect of brand awareness also provides additional value to the customer. In this case, the customer has a clear impression of where to go for assistance with a product or for product services.

The retail space 68 also contributes to the educational aspect of brand awareness. In this case, education is provided from an experienced staff (as opposed to retail sales personnel of a big-box store). The experience of the staff also fosters hands-on experience through a face-to-face contact point.

The ticket broker area 90 also provides benefits on a number of levels. On a first level, a direct profit may be generated form the sale of tickets. Tickets to any local or regional events (e.g., sports, cultural, dramatic, etc.) may be provided.

Advertising income may be generated by allowing sponsors at popular events. The ticket broker area 90 benefits customers because of the easy access along the periphery of the space 40.

Where the satellite operator simultaneously operates a number of live satellite radio sites 16, the ticket broker area 90 provides local and/or remote access to scheduled events by customers. Customers find it easy to access the ticket broker area 90 or get help on the road.

The ticket broker area 90 may also provide customer rewards. Discounts may be offered on tickets to special events based upon the degree of customer involvement with the satellite operator (e.g., subscriber to satellite radio, total purchases per time period made through the retail area; VIP member, etc.).

The offices 72 provide a single point of sales. Sales in this case can be retail sales of satellite receivers, advertising sales, broadcast sales, etc.

The museum 70 also provides a number of benefits. By visiting the museum 70, customers become aware of what satellite radio is and how it operates as well as the identity of the satellite operator. The museum 70 functions to educate the consumer about satellite radio as well as foster brand awareness.

The museum 70 also has a community value. Local access combined with the importance of satellite radio may attract field trips by various groups to the live satellite radio space 16 for purposes of education and/or to participate in various events sponsored by the satellite operator. Visitors are rewarded by the additional understanding of satellite radio provided by the content of the museum 70.

In addition to the content of the space 16, other features on an exterior of the space (e.g., a marquee 88) may further add to the value of the system 10. Advertising revenue may be generated from the marquee 88 by providing advertising and promotional space for partners and artists. The marquee 88 fosters brand awareness by visually connecting satellite radio with the space 16. Artists receive a benefit from the marquee 88 based upon use of their names. The marquee 88 provides physical presence on the street.

The outdoor venue created by the viewing windows 58, 64 also provides value on a number of levels. The satellite operator may receive advertising dollars from the visibility of sponsor's names through the windows 58, 64 to passersby. The outdoor venue fosters brand awareness by attracting passersby who then want to become a part of the experience of satellite radio. Artists benefit from the additional exposure. The local community benefits from exposure (e.g., the display of fundraising materials).

A specific embodiment of a satellite radio customer interface system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of operating a wireless global communication system comprising:
providing a live performance to a live audience located at a predetermined location;
generating an entertainment content from the live performance for transmission through the wireless global communication system; and
selling a subscription to a person of the audience located at the predetermined location that allows the person to receive the entertainment content of the global communication system through a wireless receiver of the subscribing person.

2. The method of operating the wireless global communication system as in claim 1 wherein the global communication system further comprises satellite radio.

3. The method of operating the wireless global communication system as in claim 1 wherein the wireless receiver further comprises a satellite radio.

4. The method of operating the wireless global communication system as in claim 1 further comprising educating the audience about the global communication system.

5. The method of operating the wireless global communication system as in claim 1 wherein the step of providing a live performance further comprises providing a plurality of simultaneously presented live performances to different portions of the audience.

6. The method of operating the wireless global communication system as in claim 5 further comprising providing a plurality of studios at the predetermined location wherein the respective live performances of the plurality of live performances are performed.

7. The method of operating the wireless global communication system as in claim 1 further comprising rewarding the person for subscribing.

8. The method of operating the wireless global communication system as in claim 1 further comprising branding the experience of the live performance.

9. The method of operating the wireless global communication system as in claim 1 further comprising creating programming specific brand awareness.

10. The method of operating the wireless global communication system as in claim 1 further comprising creating disk jockey specific brand awareness.

11. The method of operating the wireless global communication system as in claim 1 further comprising creating co-branding opportunities for retail partners.

12. The method of operating the wireless global communication system as in claim 1 wherein the provided live performance further comprises talk radio.

13. The method of operating the wireless global communication system as in claim 1 wherein the provided live performance further comprises a comedy routine.

14. The method of operating the wireless global communication system as in claim 1 wherein the provided live performance further comprises a celebrity or DJ event.

15. The method of operating the wireless global communication system as in claim 1 wherein the provided live performance further comprises a concert.

16. The method of operating the wireless global communication system as in claim 1 wherein the provided live performance further comprises an album release.

17. The method of operating the wireless global communication system as in claim 1 wherein the provided live performance further comprises a dramatic performance.

18. The method of operating the wireless global communication system as in claim 1 wherein the provided live performance further comprises a sports event.

19. An apparatus for operating a wireless global communication system comprising:
means for providing a live performance to a live audience located at a predetermined location;
means for generating an entertainment content from the live performance for transmission through the wireless global communication system; and
means for selling a subscription to a person of the audience located at the predetermined location that allows the person to receive the entertainment content of the global communication system through a wireless receiver of the subscribing person.

20. The apparatus for operating the wireless global communication system as in claim 19 wherein the global communication system further comprises satellite radio.

21. The apparatus for operating the wireless global communication system as in claim 19 wherein the wireless receiver further comprises a satellite radio.

22. The apparatus for operating the wireless global communication system as in claim 19 further comprising means for educating the audience about the global communication system.

23. The apparatus for operating the wireless global communication system as in claim 19 wherein the means for providing a live performance further comprises means for providing a plurality of simultaneously presented live performances to different portions of the audience.

24. The apparatus for operating the wireless global communication system as in claim 23 further comprising means for providing a plurality of studios at the predetermined location wherein the respective live performances of the plurality of live performances are performed.

25. The apparatus for operating the wireless global communication system as in claim 19 further comprising means for rewarding or referring the person for subscribing.

26. The apparatus for operating the wireless global communication system as in claim 19 further comprising means for branding the experience of the live performance.

27. The apparatus for operating the wireless global communication system as in claim 19 further comprising means for creating programming specific brand awareness.

28. The apparatus for operating the wireless global communication system as in claim 19 further comprising means for creating disk jockey specific brand awareness.

29. The apparatus for operating the wireless global communication system as in claim 19 further comprising means for creating co-branding opportunities for retail partners or any other advertising situation.

30. The apparatus for operating the wireless global communication system as in claim 19 wherein the provided live performance further comprises talk radio.

31. The apparatus for operating the wireless global communication system as in claim 19 wherein the provided live performance further comprises a comedy routine.

32. The apparatus for operating the wireless global communication system as in claim 19 wherein the provided live performance further comprises a celebrity event.

33. The apparatus for operating the wireless global communication system as in claim 19 wherein the provided live performance further comprises a concert.

34. The apparatus for operating the wireless global communication system as in claim 19 wherein the provided live performance further comprises an album release.

35. The apparatus for operating the wireless global communication system as in claim 19 wherein the provided live performance further comprises a dramatic performance.

36. An apparatus for operating a wireless global communication system comprising:
a live performance provided to a live audience located at a predetermined location;
an entertainment content generated from the live performance that is transmitted through the wireless global communication system; and
a subscription sold to a person of the audience located at the predetermined location that allows the person to receive the entertainment content of the global communication system through a wireless receiver of the subscribing person.

37. The apparatus for operating the wireless global communication system as in claim 36 wherein the global communication system further comprises satellite radio.

38. The apparatus for operating the wireless global communication system as in claim 36 wherein the wireless receiver further comprises a satellite radio.

39. The apparatus for operating the wireless global communication system as in claim 36 further comprising a museum that educates the audience about the global communication system.

40. The apparatus for operating the wireless global communication system as in claim 36 wherein the live performance further comprises a plurality of simultaneously presented live performances presented to different portions of the audience.

41. The apparatus for operating the wireless global communication system as in claim 40 further comprising a plurality of studios provided at the predetermined location wherein the respective live performances of the plurality of live performances are performed.

42. The apparatus for operating the wireless global communication system as in claim 36 wherein the provided live performance further comprises talk radio.

43. The apparatus for operating the wireless global communication system as in claim 36 wherein the provided live performance further comprises a comedy routine.

44. The apparatus for operating the wireless global communication system as in claim 36 wherein the provided live performance further comprises a celebrity event.

45. The apparatus for operating the wireless global communication system as in claim 36 wherein the provided live performance further comprises a concert.

46. The apparatus for operating the wireless global communication system as in claim 36 wherein the provided live performance further comprises an album release.

47. The apparatus for operating the wireless global communication system as in claim 36 wherein the provided live performance further comprises a dramatic performance.
